(19) United States
(12) Patent Application Publication
(10) Pub. No.: US 2024/0313492 A1
(43) Pub. Date: Sep. 19, 2024

(54) ELECTRIC WIRE PROCESSING APPARATUS AND ELECTRIC WIRE PROCESSING METHOD

(71) Applicant: Yazaki Corporation, Tokyo (JP)

(72) Inventors: Takuya NAKADA, Makinohara-shi (JP); Yuta Suganuma, Makinohara-shi (JP); Akihiro Mizuno, Makinohara-shi (JP)

(73) Assignee: Yazaki Corporation, Tokyo (JP)

(21) Appl. No.: 18/670,984

(22) Filed: May 22, 2024

Related U.S. Application Data
(63) Continuation of application No. PCT/JP2022/045285, filed on Dec. 8, 2022.

(30) Foreign Application Priority Data
Dec. 27, 2021 (JP) 2021-212941

(51) Int. Cl. H01R 43/052; H01R 43/055

(52) U.S. Cl. CPC H01R 43/052; H01R 43/055

(57) ABSTRACT

In an electric wire processing apparatus, an information acquisition/control unit acquires manufacturing information for manufacturing the terminal-equipped electric wire in which a terminal is crimped to at least one end of a segment electric wire, selects an electric wire, a terminal reel to be used, and a rubber plug to be used for an electric wire supply unit, an A-side terminal supply unit, a B-side terminal supply unit, an A-side rubber plug supply unit, and a B-side rubber plug supply unit based on the manufacturing information, and performs operation control of each of the electric wire supply unit, the A-side terminal supply unit, the B-side terminal supply unit, a main body mechanism, the A-side rubber plug supply unit, and the B-side rubber plug supply unit.

The present application is a continuation application of International Application No. PCT/JP2022/045285, filed on Dec. 8, 2022, whose priority is claimed on Japanese Patent Application No. 2021-212941, filed on Dec. 27, 2021. All of the contents of the International Application and the Japanese Patent Application are incorporated herein with reference.

### TECHNICAL FIELD

The present invention relates to an electric wire processing apparatus and an electric wire processing method for cutting out a segment electric wire and manufacturing a terminal-equipped electric wire.

### BACKGROUND ART

In related art, as an example of an electric wire processing apparatus that cuts out a segment electric wire and manufactures a terminal-equipped electric wire, an electric wire processing apparatus that cuts an electric wire selected based on manufacturing information, such as a product number, and crimps a rotated terminal in the same manner is known (for example, refer to PTL 1). In the electric wire processing apparatus described in PTL 1, cutting out and the like of the electric wire are performed in prior to terminal crimping, and the cut segment electric wire is set at a position where the terminal crimping is performed.

### CITATION LIST

### Patent Literature

[Patent Literature 1] Japanese Patent No. 6195468

### SUMMARY OF INVENTION

### Technical Problem

Here, in the electric wire processing apparatus described above, the terminal crimping and the cutting out and the like of the electric wire in the pre-process are separately performed, and there is room for improvement in terms of efficiency of an entire operation.

Accordingly, the present invention has been made in view of the above problems, and an object thereof is to provide an electric wire processing apparatus and an electric wire processing method capable of efficiently performing an entire operation for manufacturing a terminal-equipped electric wire.

### Solution to Problem

In order to solve the above problems, an electric wire processing apparatus includes an information acquisition unit configured to, in order to cut out a segment electric wire or to manufacture a terminal-equipped electric wire in which a terminal is crimped to at least one end of the segment electric wire, acquire a manufacturing information including a type of electric wire for the segment electric wire and a type of terminal for the terminal, an electric wire supply unit configured to hold a plurality of types of electric wires, and to supply, in response to selection of an electric wire to be used out of the plurality of types of electric wires, the electric wire to be used, a terminal supply unit configured to hold a plurality of types of terminal reels each having a terminal type different from each other, wherein a band-shaped terminal chain body in which a plurality of terminals are connected to each other is wound around each of the terminal reels, the terminal supply unit being configured to supply, in response to selection of a terminal reel to be used out of the plurality of types of terminal reels, the terminal reel to be used, a main body mechanism configured to cut out the segment electric wire from the electric wire to be used or to manufacture the terminal-equipped electric wire by crimping the terminal of the terminal reel to be used to at least the one end of the segment electric wire and a control unit configured to select the electric wire to be used and the terminal reel to be used for the electric wire supply unit and the terminal supply unit based on the manufacturing information acquired by the information acquisition unit, and to control each of the information acquisition unit, the electric wire supply unit, the terminal supply unit, and the main body mechanism.

### Advantageous Effects of Invention

According to the electric wire processing apparatus and the electric wire processing method described above, an entire operation for manufacturing a terminal-equipped electric wire can be efficiently performed.

### BRIEF DESCRIPTION OF DRAWINGS

FIG. 1 is an external view showing an embodiment of an electric wire processing apparatus.

FIG. 2 is a schematic view showing a main part of the electric wire processing apparatus shown in FIG. 1 which cuts a segment electric wire and crimps a terminal.

FIG. 3 is a schematic view showing an example of a terminal-equipped electric wire manufactured in the electric wire processing apparatus shown in FIGS. 1 and 2.

FIG. 4 is an external perspective view showing an electric wire supply unit shown in FIGS. 1 and 2.

FIG. 5 is an external perspective view showing, in an enlarged manner, a periphery of a B-side terminal supply unit in the electric wire processing apparatus shown in FIGS. 1 and 2.

FIG. 6 is an external perspective view showing a terminal reel unit shown in FIG. 5 in a state in which a terminal reel is held.

FIG. 7 is a flowchart showing a flow of acquisition of product number data, various types of selection associated with the product number data, and operation of each part which has received the selection in an electric wire processing method executed in the electric wire processing apparatus shown in FIGS. 1 to 6.

FIG. 8 is a view showing a state in which an electric wire is supplied by the electric wire supply unit in steps S103 and S104 of the flowchart in FIG. 7.

FIG. 9 is a view showing a state in which terminal reels to be used are supplied by an A-side terminal supply unit and the B-side terminal supply unit in steps S105 to S108 of the flowchart in FIG. 7 by using processing of steps S107 and S108 on a B side as a representative example.

FIG. 10 is a flowchart showing a manufacturing process of a terminal-equipped electric wire of a both-end crimping type, which is executed following processing of the flowchart in FIG. 7, in the electric wire processing method executed in the electric wire processing apparatus shown in FIGS. 1 to 6.

FIG. 11 is a schematic view showing a state in which electric wire initial feeding and electric wire tip trimming are executed in a main body mechanism shown in FIG. 2.

FIG. 12 is a schematic view showing processing contents of step S114 and subsequent steps in the flowchart of FIG. 10.

FIG. 13 is a schematic view showing processing contents of step S115 and subsequent steps in the flowchart of FIG. 10.

FIG. 14 is a schematic view showing a state in which processing of step S120 and subsequent steps and processing of step S125 and subsequent steps are executed in parallel in the flowchart of FIG. 10.

FIG. 15 is a schematic view showing a state in which only processing of steps S125 to S128 is executed at a time of last crimping in the flowchart of FIG. 10.

### DESCRIPTION OF EMBODIMENTS

Hereinafter, an embodiment of an electric wire processing apparatus and an electric wire processing method will be described.

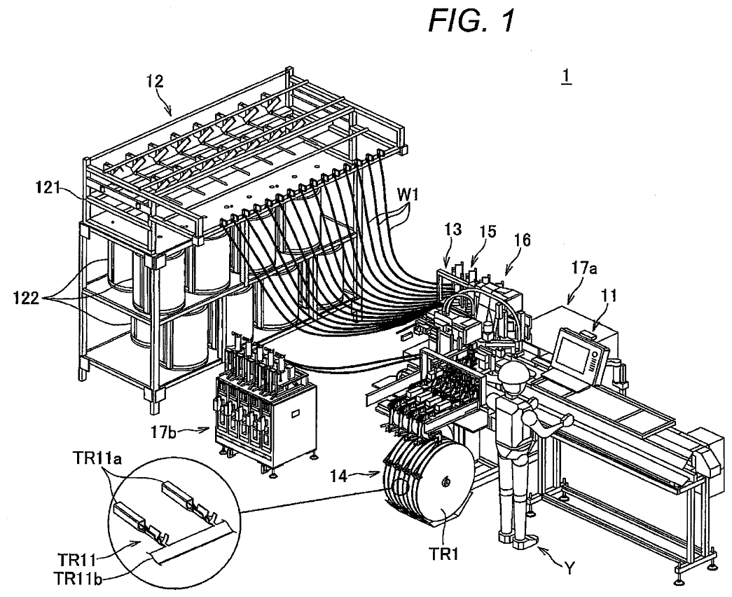

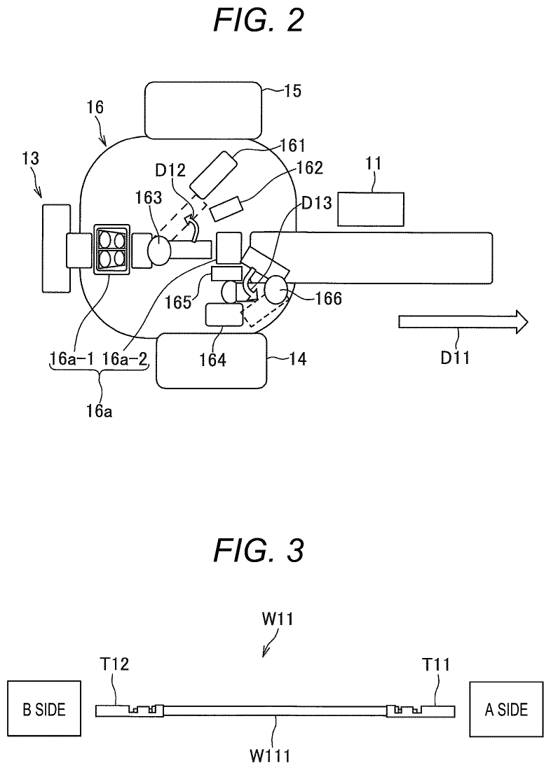

FIG. 1 is an external view showing an embodiment of the electric wire processing apparatus, and FIG. 2 is a schematic view showing a main part of the electric wire processing apparatus shown in FIG. 1 which cuts a segment electric wire and crimps a terminal. FIG. 3 is a schematic view showing an example of a terminal-equipped electric wire manufactured in the electric wire processing apparatus shown in FIGS. 1 and 2.

An electric wire processing apparatus 1 shown in FIGS. 1 and 2 is an apparatus that manufactures a terminal-equipped electric wire W11 of which an example is shown in FIG. 3, for example. FIG. 3 illustrates the terminal-equipped electric wire W11 in which terminals are crimped to both ends of a segment electric wire W111.

Here, when the terminal-equipped electric wire W11 shown in FIG. 3 is manufactured by the electric wire processing apparatus 1, electric wires W1 to be supplied as described later, are reeled out in a reel-out direction D11 indicated by an arrow in FIG. 2 and the segment electric wire W111 is cut out. At this time, a front side in the reel-out direction D11 is referred to as an A side and a rear side is referred to as a B side, a terminal crimped to the A side of the segment electric wire W111 is referred to as an A-side terminal T11, and a terminal crimped to the B side is referred to as a B-side terminal T12.

The terminal-equipped electric wire that can be manufactured by the electric wire processing apparatus 1 is not limited to a form in FIG. 3, and a terminal-equipped electric wire in which a terminal is crimped to only one end of the segment electric wire W111 can also be manufactured. Although not shown in the drawings, it is possible to manufacture either a segment electric wire of a rubber plug insertion type in which a terminal is crimped from a top of a waterproof rubber plug inserted at one end thereof or a segment electric wire of a rubber plug non-insertion type in which terminal crimping is directly performed. Further, in the electric wire processing apparatus 1, it is also possible to perform only cutting of the segment electric wire W111 including stripping of an end portion without performing the terminal crimping. Which one of the plurality of forms is to be manufactured by the electric wire processing apparatus 1 is selected through manufacturing information related to target electric wire processing.

The electric wire processing apparatus 1 includes an information acquisition/control unit 11, an electric wire storage rack 12, an electric wire supply unit 13, a B-side terminal supply unit 14, an A-side terminal supply unit 15, a main body mechanism 16, an A-side rubber plug supply unit 17a, and a B-side rubber plug supply unit 17b.

Regarding the information acquisition/control unit 11, first, an information acquisition function will be described, and a control function will be described later. Regarding the information acquisition function, the information acquisition/control unit 11 acquires, as the manufacturing information, information indicating that only the cutting of the segment electric wire W111 is performed and product number data associated with a type of the segment electric wire W11i in response to an input operation of an operator Y Regarding the manufacturing of the terminal-equipped electric wire W11, the manufacturing information including the type of the segment electric wire W111 and a type of the terminal is acquired. Specifically, the information acquisition/control unit 11 receives the input operation of the operator Y and acquires the product number data associated with the electric wire type and the terminal type as the manufacturing information. The product number data is associated with various kinds of information such as an electric wire type, a terminal type, a crimping type of both ends/one end, a rubber plug insertion type, and a rubber plug type in the case of the rubber plug insertion type. Furthermore, in the present embodiment, the product number data is also associated with a required number of the electric wires to be manufactured.

In the electric wire storage rack 12, a plurality of electric wire reels 122 of different electric wire types are accommodated in a rack body 121. Electric wires wound around the plurality of electric wire reels 122 are covered electric wires having different thicknesses, colors, and the like. Further, the electric wires W1 drawn out from a predetermined number of electric wire reels 122 selected from the plurality of electric wire reels 122 are extended to the electric wire supply unit 13 as candidates for cutting out of the segment electric wire W111.

The electric wire supply unit 13 is a device in which an electric wire to be supplied is selected from among a plurality of types of electric wires W1 from the electric wire storage rack 12, and the electric wire is supplied to a supply position for the terminal crimping.

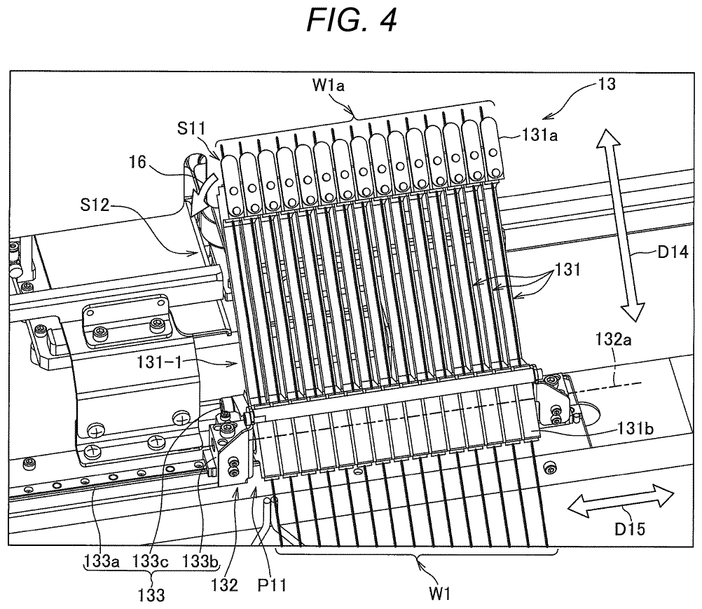

FIG. 4 is an external perspective view showing the electric wire supply unit shown in FIGS. 1 and 2. FIG. 4 is a perspective view of the electric wire supply unit 13 as viewed from the electric wire storage rack 12 in FIG. 1.

The electric wire supply unit 13 includes a plurality of electric wire holding arms 131, a holding frame 132, and a moving mechanism 133.

The electric wire holding arm 131 is formed in a rod shape, and detachably holds one electric wire W1 along a length direction D14 thereof, has one end side as an electric wire protruding end portion 131a, and causes a tip W1a of the electric wire W1 to protrude from the electric wire protruding end portion 131a. The electric wire supply unit 13 is provided with the plurality of electric wire holding arms 131 that hold the plurality of types of electric wires W1 on a one-to-one basis.

The holding frame 132 is a member that holds the plurality of electric wire holding arms 131 arranged side by side in a width direction D15 intersecting the length direction D14 of the wire holding arms 131. In this holding, each of the electric wire holding arms 131 is individually held in a manner of being movable between two postures of a standby posture S11 and an electric wire supply posture S12. FIG. 4 shows the electric wire supply unit 13 in a state where the entire holding frame 132 is in the standby posture S11. The standby posture S11 is a posture in which the length direction D14 of the electric wire holding arm 131 is aligned with the length direction D14 of another wire holding arm 131 in a standing state in which the electric wire protruding end portion 131a is higher than an opposite end portion 131b. On the other hand, the electric wire supply posture S12 is a posture tilted in a direction indicated by an arrow D16 such that the electric wire protruding end portion 131a is lower than the electric wire protruding end portion 131a of the other electric wire holding arm 131.

The holding frame 132 individually holds each of the plurality of electric wire holding arms 131 in the manner of being movable between the standby posture S11 and the electric wire supply posture S12. Specifically, the holding frame 132 individually holds each of the electric wire holding arms 131 such that the electric wire holding arms 131 are rotatable between the standby posture S11 and the electric wire supply posture S12 about a rotation axis 132a intersecting the opposite end portion 131b.

When the electric wire to be supplied is selected, the moving mechanism 133 moves the holding frame 132 such that a supply arm 131-1 holding the electric wire among the plurality of electric wire holding arms 131 is positioned at a predetermined supply position P11. The supply position P11 is a position at which, when the supply arm 131-1 moves to the electric wire supply posture S12, the tip W1a of the electric wire protruding from the electric wire protruding end portion 131a enters a reel-out mechanism 16a-1 to be described later shown in FIG. 2. After the moving mechanism 133 moves the holding frame 132 to position the supply arm 131-1 at the supply position P11, the moving mechanism 133 moves the supply arm 131-1 to the electric wire supply posture S12 at the supply position P11. The moving mechanism 133 includes a holding rail 133a, a slide driving unit 133b, and an arm driving unit 133c.

The holding rail 133a is a rail that passes through the supply position P11 and extends along an arrangement direction (that is, the width direction D15 of the electric wire holding arms 131) of the electric wire holding arms 131 in the holding frame 132. Further, the holding rail 133a slidably and movably holds the holding frame 132 that holds the plurality of electric wire holding arms 131 arranged side by side in the standby posture S11.

The slide driving unit 133b slides the holding frame 132 on the holding rail 133a such that the supply arm 131-1 among the plurality of electric wire holding arms 131 arranged side by side is positioned at the supply position P11. Examples of a driving source in the slide driving unit 133b include a servo motor.

The arm driving unit 133c rotates the supply arm 131-1 positioned at the supply position P11 from the standby posture S11 to the electric wire supply posture S12 around the rotation axis 132a and tilts the supply arm 131-1 down. Examples of a driving source in the arm driving unit 133c include a general motor other than a cylinder.

Next, each of the B-side terminal supply unit 14 and the A-side terminal supply unit 15 shown in FIGS. 1 and 2 holds a plurality of types of terminal reels TR1 different in terminal type, and around the terminal reel TR1, a terminal chain body TR11 in which a plurality of terminals TR11a are connected via a band-shaped carrier TR11b is wound. The B-side terminal supply unit 14 holds the plurality of types of terminal reels TR1 as candidates for the B-side terminal T12, and the A-side terminal supply unit 15 holds the plurality of types of terminal reels TR1 as candidates for the A-side terminal T11. Further, the B-side terminal supply unit 14 and the A-side terminal supply unit 15 supply the terminal reels to be used when the terminal reels to be used are respectively selected from among the plurality of types of terminal reels TR1 for the B side and the A side. The B-side terminal supply unit 14 and the A-side terminal supply unit 15 have substantially the same structure as described below. Hereinafter, the B-side terminal supply unit 14 will be described as a representative example, and the structure of the terminal supply unit will be described.

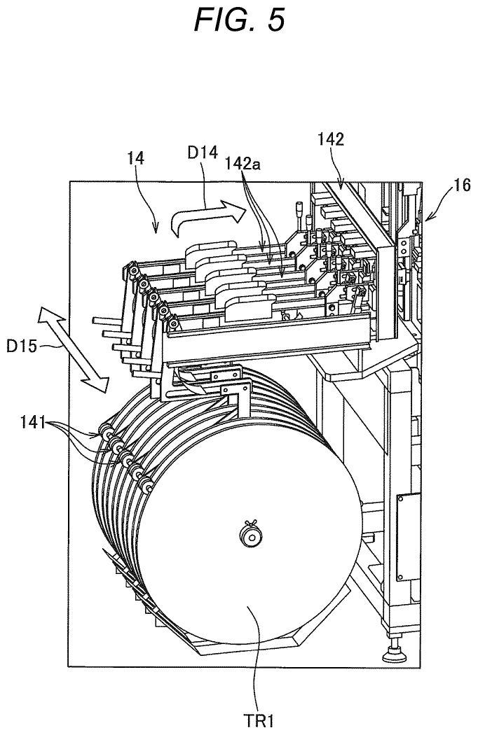

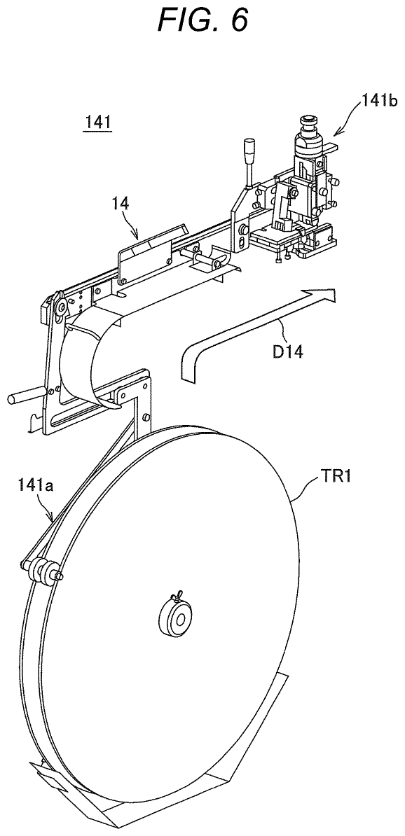

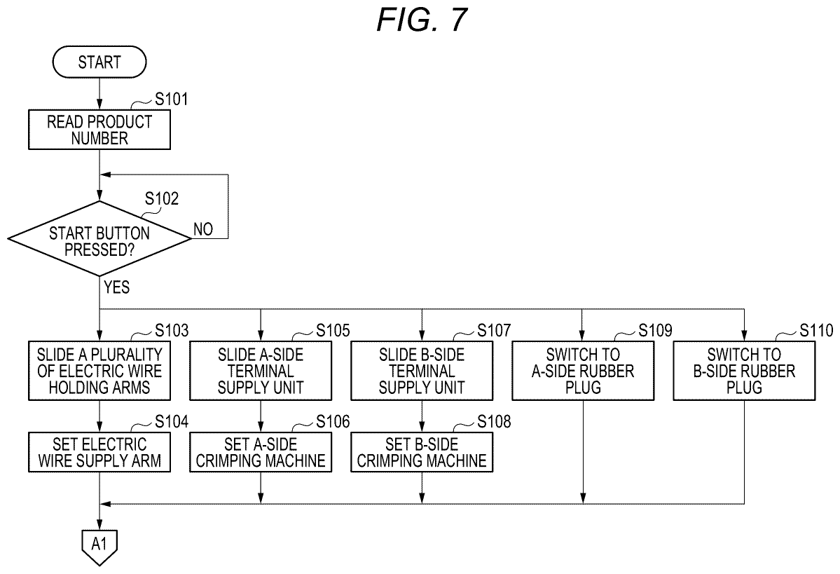

FIG. 5 is an external perspective view showing, in an enlarged manner, a periphery of the B-side terminal supply unit in the electric wire processing apparatus shown in FIGS. 1 and 2, and FIG. 6 is an external perspective view showing a terminal reel unit shown in FIG. 5 in a state in which the terminal reel is held.

The B-side terminal supply unit 14 includes a plurality of terminal reel units 141 and a supply mechanism 142. Each of the terminal reel units 141 is a member that detachably holds the terminal reel TR1. Further, in the supply mechanism 142, the plurality of terminal reel units 141 are detachably set in a state of holding the plurality of types of terminal reels TR1 different in terminal type on a one-to-one basis. The supply mechanism 142 is provided with a plurality of receiving slots 142a that receive the plurality of terminal reel units 141 on a one-to-one basis.

The terminal reel unit 141 includes a reel holding portion 141a, a crimping portion 141b, and a unit frame 141c. The reel holding portion 141a is a portion that detachably holds the terminal reel TR1. The crimping portion 141b is a member that is disposed at a position in front of the terminal reels TR1 in a pull-out direction D14 of the terminal chain body TR11 from the terminal reel TR1 when the terminal reel TR1 is held by the reel holding portion 141a, and performs the terminal crimping. The unit frame 141c is a frame detachably set to the supply mechanism 142 in the electric wire processing apparatus 1 that supplies the electric wires W1 to the crimping portion 141b, and the reel holding portion 141a and the crimping portion 141b are attached to the unit frame 141c. As described above, the supply mechanism 142 is provided with the plurality of receiving slots 142a, and the unit frame 141c can be inserted into and removed from the receiving slot 142a.

The main body mechanism 16 cuts out the segment electric wire W111 from the electric wire supplied from the electric wire supply unit 13, and crimps terminals of the supplied terminal reel to end portions on the B side and the A side of the segment electric wire W111 to manufacture the terminal-equipped electric wire W11. First, the main body mechanism 16 includes a cut-out portion 16a that cuts out the segment electric wire W111 by reeling out the electric wire in the reel-out direction D11 and cutting the electric wire. The cut-out portion 16a includes the reel-out mechanism 16a-1 that performs the reeling out and a cutting mechanism 16a-2 that performs the cutting. The cutting mechanism 16a-2 is a mechanism capable of stripping a coating on the end portions of the cut electric wire.

The main body mechanism 16 shown in FIGS. 1 and 2 includes an A-side crimping machine 161, an A-side rubber plug inserting machine 162, and an A-side electric wire moving arm 163 as mechanism portions for terminal crimping on the A side. Here, the terminal crimping on the A side refers to terminal crimping to a front end of the electric wire in the reel-out direction D11. The A-side crimping machine 161 crimps the terminal of the terminal reel supplied by the A-side terminal supply unit 15 as the A-side terminal T11 to the front end of the electric wire in the reel-out direction D11. When an A-side rubber plug to be used is supplied from the A-side rubber plug supply unit 17a as to be described later, the A-side rubber plug inserting machine 162 inserts the A-side rubber plug to the front end of the electric wire in the reel-out direction D11 prior to the terminal crimping by the A-side crimping machine 161. In this case, the terminal crimping by the A-side crimping machine 161 is performed from above the inserted rubber plug. The A-side electric wire moving arm 163 is an A-side arm mechanism that grips the electric wire reeled out by the cut-out portion 16a, moves the front end of the electric wire in the reel-out direction D11 in a direction indicated by an arrow D12, and positions the electric wire with respect to the A-side crimping machine 161 and the A-side rubber plug inserting machine 162.

The main body mechanism 16 includes a B-side crimping machine 164, a B-side rubber plug inserting machine 165, and a B-side electric wire moving arm 166 as mechanism portions for terminal crimping on the B side. Here, the terminal crimping on the B side refers to terminal crimping on a rear end, in the reel-out direction D11, of the terminal-equipped segment electric wire that is cut out after the terminal crimping by the A-side crimping machine 161 is performed. The B-side crimping machine 164 crimps the terminal of the terminal reel supplied by the B-side terminal supply unit 14 as the B-side terminal T12 to the rear end of the terminal-equipped segment electric wire in the reel-out direction D11. When a B-side rubber plug to be used is supplied from the B-side rubber plug supply unit 17b as to be described later, the B-side rubber plug inserting machine 165 inserts the B-side rubber plug to the rear end of the terminal-equipped segment electric wire in the reel-out direction D11 prior to the terminal crimping by the B-side crimping machine 164. In this case, the terminal crimping by the B-side crimping machine 164 is performed from above the inserted rubber plug. The B-side electric wire moving arm 166 is a B-side arm mechanism that grips the terminal-equipped segment electric wire cut out by the cut-out portion 16a, moves the rear end of the terminal-equipped segment electric wire in the reel-out direction D11 along a direction indicated by an arrow D13, and positions the terminal-equipped segment electric wire with respect to the B-side crimping machine 164 and the B-side rubber plug inserting machine 165.

In the present embodiment, when the supply mechanism 142 moves one terminal reel unit, the crimping portion 141b on the one terminal reel unit is assembled into the main body mechanism 16. The crimping portion 141b thus assembled is a mechanism portion for terminal crimping in the A-side crimping machine 161 on the A side, and is a mechanism portion for terminal crimping in the B-side crimping machine 164 on the B side.

The A-side rubber plug supply unit 17a and the B-side rubber plug supply unit 17b are devices each holding a plurality of types of rubber plugs and respectively supply the rubber plugs to the A-side rubber plug inserting machine 162 and the B-side rubber plug inserting machine 165. When a target is a terminal-equipped electric wire of a rubber plug insertion type, the A-side rubber plug supply unit 17a and the B-side rubber plug supply unit 17b supply, based on the product number data, the rubber plug of a selected rubber plug type to the A-side rubber plug inserting machine 162 and the B-side rubber plug inserting machine 165, respectively.

Next, the control function of the information acquisition/control unit 11 will be described. Regarding the control function, the information acquisition/control unit 11 performs various types of selection for the electric wire supply unit 13, the A-side terminal supply unit 15, the B-side terminal supply unit 14, the A-side rubber plug supply unit 17a, and the B-side rubber plug supply unit 17b based on the acquired product number data. The electric wire is selected for the electric wire supply unit 13.

For the A-side terminal supply unit 15 and the B-side terminal supply unit 14, when a one-end crimping type is selected in the product number data, the terminal reel is selected only for the A-side terminal supply unit 15 or the B-side terminal supply unit 14. On the other hand, when a both-end crimping type is selected, the terminal reel is selected for both the A-side terminal supply unit 15 and the B-side terminal supply unit 14.

When the rubber plug insertion type is selected in addition to the one-end crimping type in the product number data, only a rubber plug type for the A-side rubber plug inserting machine 162 or the B-side rubber plug inserting machine 165 is selected for the A-side rubber plug supply unit 17a or the B-side rubber plug supply unit 17b. On the other hand, when the rubber plug insertion type is selected together with the both-end crimping type, both the rubber plug type for the A-side rubber plug inserting machine 162 and the rubber plug type for the B-side rubber plug inserting machine 165 are selected. In a case where only the cutting of the segment electric wire W111 is selected in the product number data, only the electric wire type for the electric wire supply unit 13 is selected with respect to material selection.

The information acquisition/control unit 11 performs operation control of the electric wire supply unit 13, the A-side terminal supply unit 15, the B-side terminal supply unit 14, the main body mechanism 16, the A-side rubber plug supply unit 17a, and the B-side rubber plug supply unit 17b. Hereinafter, the electric wire processing method executed in the electric wire processing apparatus 1 under the operation control by the information acquisition/control unit 11 will be described. In the following description, the manufacturing of the terminal-equipped electric wire W11 in the case where the both-end crimping type and the rubber plug non-insertion type for the rubber plug are selected will be described as an example.

In the electric wire processing apparatus 1, first, acquisition of the product number data, various types of selection associated with the product number data, and operation of each part that has received the selection are performed.

FIG. 7 is a flowchart showing a flow of acquisition of the product number data, various types of selection associated with the product number data, and operation of each part which has received the selection in the electric wire processing method executed in the electric wire processing apparatus shown in FIGS. 1 to 6. Processing of this flowchart starts when the electric wire processing apparatus 1 is powered on.

When the processing starts, first, an information acquisition process is executed in which the information acquisition/control unit 11 acquires the target product number data of the terminal-equipped electric wire (step S101). Processing of step S101 is performed by the operator Y inputting the product number data to the information acquisition/control unit 11. Here, in the product number data, it is assumed that the both-end crimping type and the rubber plug non-insertion type for the rubber plug are selected, and a plurality of manufactured electric wires are selected. After the acquisition of the product number data, the electric wire processing apparatus 1 enters a standby state of waiting for a press of a start button supporting a start of manufacturing (step S102). While the start button is not pressed (NO determination in step S102), the standby state continues.

When the start button is pressed (YES determination in step S102), in the electric wire processing apparatus 1, processing of steps S103 to S108 among steps S103 to S110 is executed in parallel under the control of the information acquisition/control unit 11.

First, in steps S103 and S104, the electric wire to be supplied is selected from the information acquisition/control unit 11, and the electric wire is supplied by the electric wire supply unit 13 based on the selection. That is, processing of steps S103 and S104 are processing in which a selection process in which the information acquisition/control unit 11 selects the electric wire for the electric wire supply unit 13 based on the product number data and a supply process in which the electric wire supply unit 13 supplies the electric wire are combined.

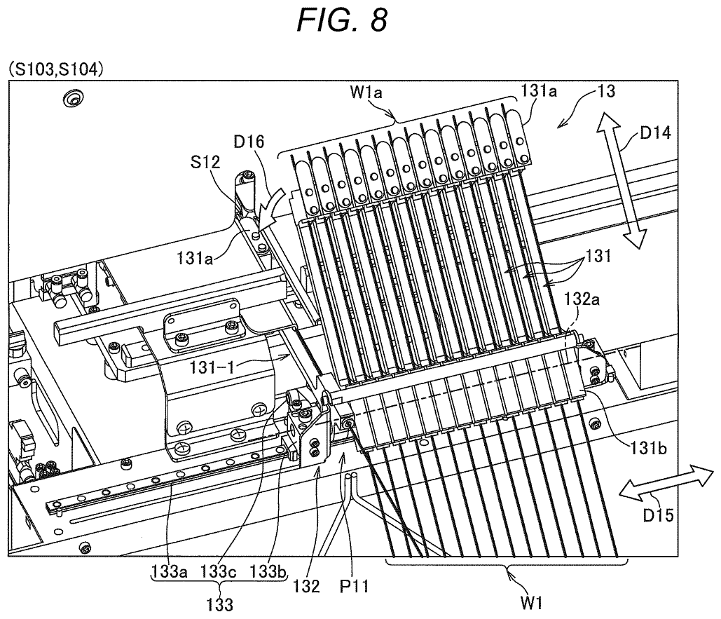

FIG. 8 is a view showing a state in which the electric wire is supplied by the electric wire supply unit in steps S103 and S104 of the flowchart in FIG. 7.

FIG. 8 shows a state in which, among the plurality of electric wire holding arms 131 arranged side by side, the supply arm 131-1 at a left end as viewed from the electric wire storage rack 12 in FIG. 1 is shifted to the electric wire supply posture S12, and the held electric wire W1 is supplied as the electric wire. The electric wire supply posture S12 is the posture tilted in the direction indicated by the arrow D16 such that the electric wire protruding end portion 131a is lower than the electric wire protruding end portion 131a of the other electric wire holding arm 131. In the electric wire supply posture S12, the tip W1a of the electric wire enters the reel-out mechanism 16a-1 shown in FIG. 2 and can be reel out. The following operations are performed until the supply arm 131-1 shifts to the electric wire supply posture S12.

First, when the electric wire to be supplied is selected from the information acquisition/control unit 11, the following operation is executed in the moving mechanism 133. That is, the slide driving unit 133b slides the holding frame 132 on the holding rail 133a such that the supply arm 131-1 among the plurality of electric wire holding arms 131 arranged side by side is positioned at the supply position P11 (step S103). Next, the arm driving unit 133c rotates the supply arm 131-1 positioned at the supply position P11 from the standby posture S11 to the electric wire supply posture S12 around the rotation axis 132a and tilts the supply arm 131-1 down (step S104).

Next, in steps S105 and S106 of the flowchart in FIG. 7, the both-end crimping type and the A-side terminal reel are selected from the information acquisition/control unit 11. Based on this selection, the terminal reel is supplied by the A-side terminal supply unit 15, and the crimping portion is set. Similarly, in steps S107 and S108 of the flowchart, the both-end crimping type and the B-side terminal reel are selected from the information acquisition/control unit 11. Further, based on this selection, the terminal reel is supplied by the B-side terminal supply unit 14, and the crimping portion is set. Processing of steps S105 and S106 are processing combining the selection process and the supply process for the A-side terminal reel, and processing of steps S107 and S108 are processing combining a selection process and a supply process for the B-side terminal reel. In the present embodiment, since the processing on the A side and the B side are substantially the same, the processing of steps S107 and S108 related to the B side will be described below as a representative example.

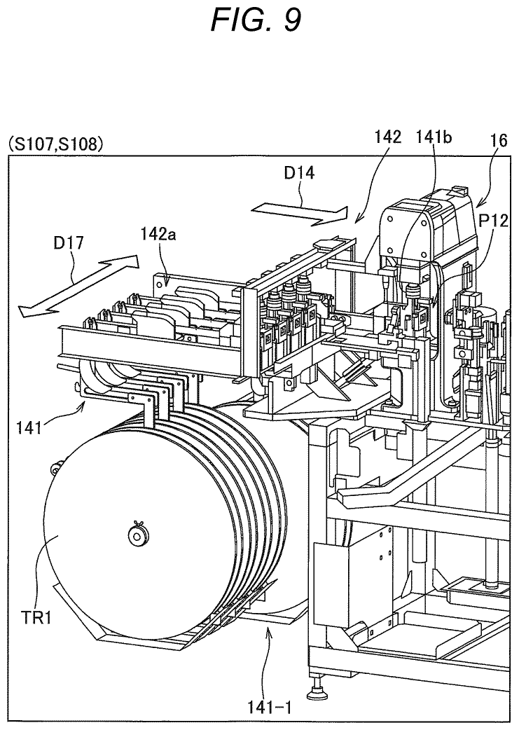

FIG. 9 is a view showing a state in which the terminal reels are supplied by the A-side terminal supply unit and the B-side terminal supply unit in steps S105 to S108 of the flowchart in FIG. 7 by using the processing of steps S107 and S108 on the B side as a representative example.

When the terminal reel is selected, the supply mechanism 142 moves one terminal reel unit 141-1 holding the terminal reel among the plurality of terminal reel units 141. In an example of FIG. 9, a portion on the deepest side in a depth direction in the drawing is the one terminal reel unit 141-1 to be moved. When the one terminal reel unit 141-1 is determined based on the product number data, the supply mechanism 142 performs the following two-stage moving operation.

First, the supply mechanism 142 slides the plurality of terminal reel units 141 in an arrangement direction D17 until the crimping portion 141b of the one terminal reel unit 141-1 is aligned with a crimping machine set position P12 in the pull-out direction D14 (step S107). The crimping machine set position P12 is a position where the crimping portion 141b is incorporated into the B-side crimping machine 164 and terminal crimping is performed in the main body mechanism 16. When the crimping portion 141b is set at the crimping machine set position P12, the crimping portion 141b is connected to various driving sources, and the B-side crimping machine 164 (the same applies to the A-side crimping machine 161) shown in FIG. 2 is constructed. In the present embodiment, examples of the crimping portion of the terminal reel unit include the crimping portion 141b constituting a part of the B-side crimping machine 164. However, the crimping portion of the terminal reel unit is not limited thereto. The crimping portion may include an entire configuration of the crimping machine including various driving sources as long as the crimping portion constitutes at least a part of the crimping machine that performs the terminal crimping in the main body mechanism. The same applies to the A side. The sliding movement in step S107 is performed by sliding the plurality of receiving slots 142a receiving the plurality of terminal reel units 141 in the arrangement direction D17.

Following the processing of step S107, the supply mechanism 142 pushes the one terminal reel unit 141-1 in the pull-out direction D14 until the crimping portion 141b reaches the crimping machine set position P12. By this pushing, the crimping portion 141b is set at the crimping machine set position P12, and the B-side crimping machine 164 is constructed (step S108).

As described above, in steps S105 and S106, the same processing is performed, and the supply of the terminal reel and the setting of the crimping portion are performed.

Step S109 and step S110 in the flowchart of FIG. 7 are both processing in the case where the rubber plug insertion type is selected, and are not executed in this example. The processing of step S109 is processing in which the A-side rubber plug supply unit 17a supplies the rubber plug to the A-side rubber plug inserting machine 162 when the A-side rubber plug is selected from among the plurality of types of rubber plugs. Similarly, the processing of step S110 is processing in which the B-side rubber plug supply unit 17b supplies the rubber plug to the B-side rubber plug inserting machine 165 when the B-side rubber plug is selected from among the plurality of types of rubber plugs.

As described above, by the processing with reference to FIGS. 7 to 9, preparation for the manufacturing process of manufacturing the terminal-equipped electric wire W11 of the both-end crimping type in the main body mechanism 16 is completed.

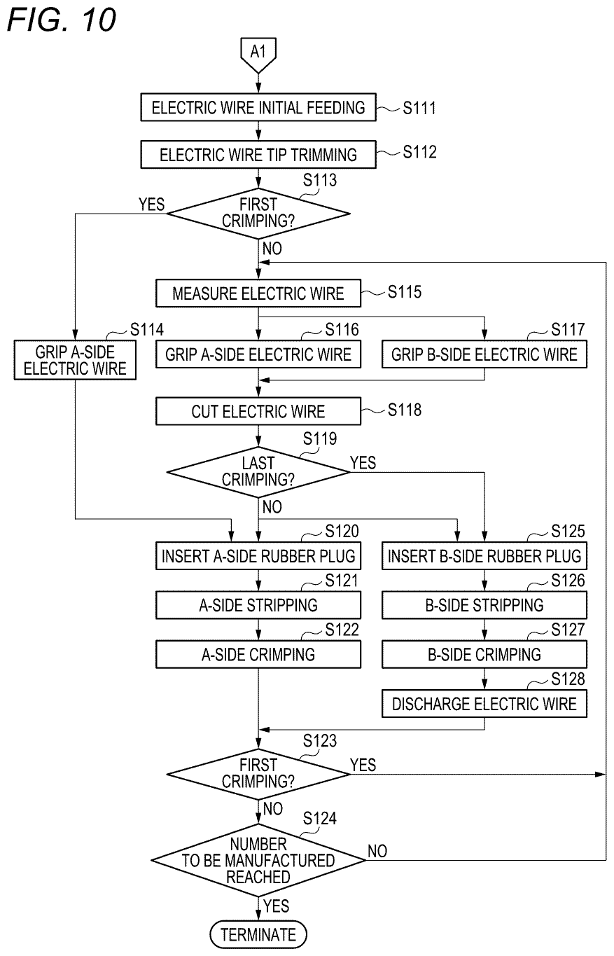

FIG. 10 is a flowchart showing the manufacturing process of the terminal-equipped electric wire of the both-end crimping type, which is performed following the processing of the flowchart in FIG. 7, in the electric wire processing method executed in the electric wire processing apparatus shown in FIGS. 1 to 6.

In processing of the flowchart of FIG. 10, first, in the main body mechanism 16 shown in FIG. 2, electric wire initial feeding (step S111) by the reel-out mechanism 16a-1 and electric wire tip trimming (step S112) subsequent thereto are executed.

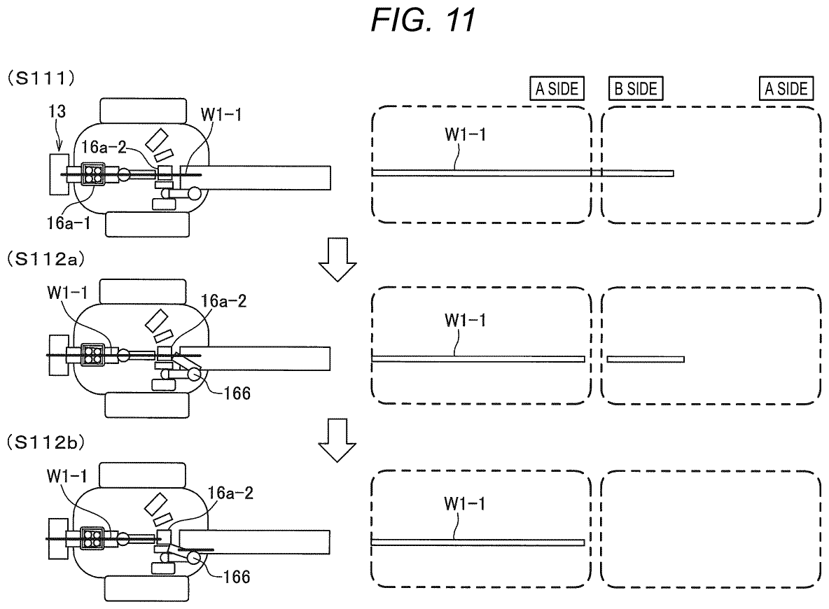

FIG. 11 is a schematic view showing a state in which the electric wire initial feeding and the electric wire tip trimming are executed in a main body mechanism shown in FIG. 2.

First, the electric wire initial feeding (step S111) is processing in which an electric wire W1-1 supplied from the electric wire supply unit 13 is reeled out by the reel-out mechanism 16a-1 to a length at which the electric wire W1-1 can be cut by the cutting mechanism 16a-2.

In the electric wire tip trimming (step S112), cutting processing (S112a) and discarding processing (S112b) are performed. The cutting processing (S112a) is processing in which the B-side electric wire moving arm 166 grasps a tip portion of the electric wire W1-1 reeled out beyond the cutting mechanism 16a-2 and the cutting mechanism 16a-2 cuts the electric wire W1-1. The discarding processing (S112b) is processing in which the B-side electric wire moving arm 166 carries the cut tip portion to a discarding place which is opened to discard the cut tip portion.

In the processing of the flowchart of FIG. 10, the electric wire processing apparatus 1 next determines whether current crimping is first crimping performed after the electric wire tip trimming (step S113). In the case of the first crimping (YES determination in step S113), the processing proceeds to step S114 and subsequent steps, and in the case of not the first crimping (NO determination in step S113), the processing proceeds to step S115 and subsequent steps. First, the case of the first crimping will be described.

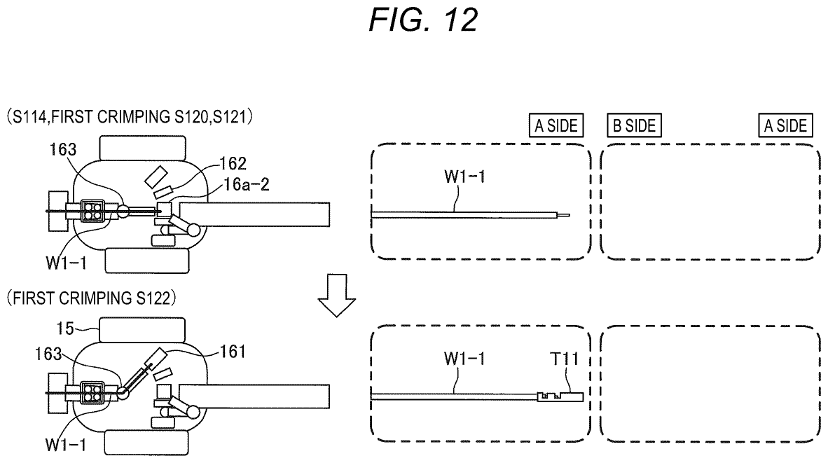

FIG. 12 is a schematic view showing processing contents of step S114 and the subsequent steps in the flowchart of FIG. 10. Hereinafter, the processing of step S114 and the subsequent steps will be described with reference to FIG. 12 together with the flowchart in FIG. 10.

First, in processing of step S114, the electric wire W1-1 of which the tip portion is cut by the above-described electric wire tip trimming (step S112) is gripped by the A-side electric wire moving arm 163. Thereafter, processing proceeds to steps S120 and S121. Step S120 is A-side rubber plug insertion processing by the A-side rubber plug inserting machine 162, and step S121 is A-side stripping processing by the cutting mechanism 16a-2. In this example, since the rubber plug non-insertion type is selected in the product number data for the rubber plug, the A-side rubber plug insertion processing in step S120 is not performed, and only the stripping processing in step S121 is performed.

Next, A-side crimping processing is performed by the A-side crimping machine 161 (step S122). The A-side crimping machine 161 is a mechanism constructed by setting the crimping portion in step S106 described above, and the A-side terminal T11 to be crimped is the terminal TR11a of the terminal reel set in step S106 together with the crimping portion. The A-side crimping processing is performed by the A-side electric wire moving arm 163 carrying an A-side end portion of the electric wire W1-1 to the A-side crimping machine 161.

After the A-side crimping processing in step S122, the electric wire processing apparatus 1 determines again whether the current crimping is the first crimping (step S123). In the case of the first crimping (YES determination in step S123), the processing proceeds to step S115 and the subsequent steps, and in the case of not the first crimping (NO determination in step S123), the processing proceeds to step S124 and subsequent steps. In this case, the case of the first crimping will also be described.

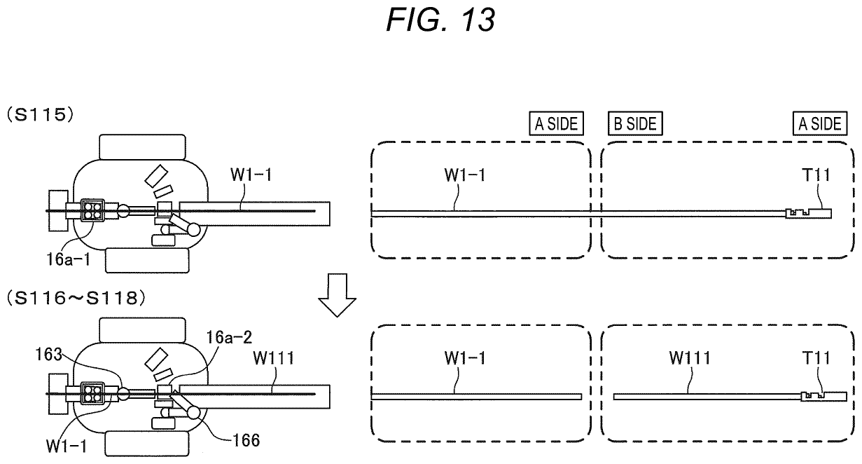

FIG. 13 is a schematic view showing processing contents of step S115 and the subsequent steps in the flowchart of FIG. 10. Hereinafter, the processing of step S115 and the subsequent steps will be described with reference to FIG. 13 together with the flowchart in FIG. 10.

In the processing of step S115, the following electric wire measuring processing is performed. First, the electric wire W1-1 to which the A-side terminal T11 is crimped is returned by the A-side electric wire moving arm 163 from the A-side crimping machine 161 to an axis in a direction in which the reel-out mechanism 16a-1 performs reeling out. Thereafter, the gripping by the A-side electric wire moving arm 163 is released, and the electric wire W1-1 is reeled out by only an electric wire length predetermined by the reel-out mechanism 16a-1. Here, the electric wire length reeled out by the reel-out mechanism 16a-1 is also associated with the product number data acquired in step S101.

Processing of steps S116 and S117 following the electric wire measuring processing of step S115 is executed in parallel. In the processing of step S116, an intermediate portion of the electric wire W1-1 reeled out as described above is gripped again by the A-side electric wire moving arm 163. In the processing of step S117, the B-side electric wire moving arm 166 grips the intermediate portion of the electric wire W1-1 separated from a position on the A side gripped by the A-side electric wire moving arm 163 with the cutting mechanism 16a-2 interposed therebetween. Further, in processing of step S118 following the electric wire gripping at these two positions, the electric wire W1-1 is cut by the cutting mechanism 16a-2. Accordingly, the terminal-equipped segment electric wire to which the A-side terminal T11 of the segment electric wire W111 is crimped is cut out.

In the flowchart of FIG. 10, the electric wire processing apparatus 1 next determines whether the current crimping is last crimping (step S119). In the case of the last crimping (YES determination in step S119), only the processing of step S125 and subsequent steps is executed. On the other hand, in the case of not the last crimping (NO determination in step S119), processing of step S120 and subsequent steps and the processing of step S125 and the subsequent steps are executed in parallel. Here, the case of not the last crimping will be described.

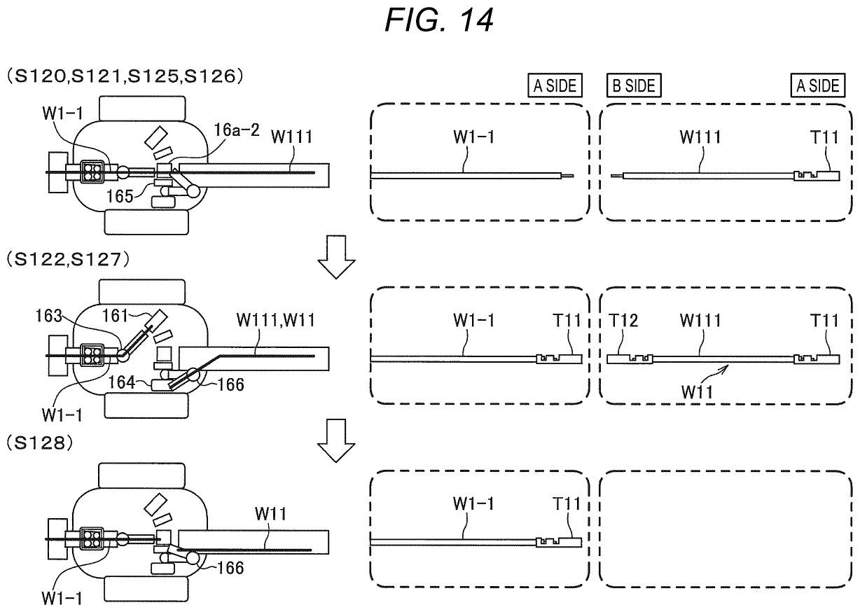

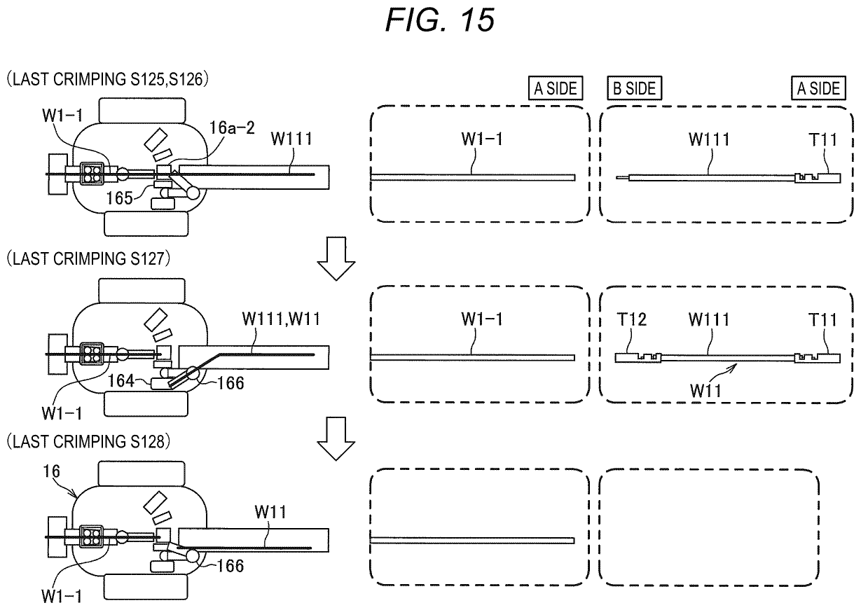

FIG. 14 is a schematic view showing a state in which the processing of step S120 and the subsequent steps and the processing of step S125 and the subsequent steps are executed in parallel in the flowchart of FIG. 10. Hereinafter, the processing of step S120 and the subsequent steps and the processing of step S125 and the subsequent steps will be described with reference to FIG. 14 together with the flowchart in FIG. 10.

First, in the flowchart of FIG. 10, the A-side rubber plug insertion processing in step S120 and the A-side stripping processing in step S121, and B-side rubber plug insertion processing in step S125 and B-side stripping processing in step S126 are executed in parallel. Again, in this example, the rubber plug insertion processing in steps S120 and S125 is not executed due to the selection of the rubber plug non-insertion type by the product number data. Here, only the stripping processing in step S121 and step S126 is executed by the cutting mechanism 16a-2.

Next, the A-side crimping processing in step S122 and B-side crimping processing in step S127 are executed in parallel. The A-side crimping processing in step S122 is performed by the A-side electric wire moving arm 163 carrying an A-side end portion of an electric wire W1-1 to the A-side crimping machine 161. The B-side crimping processing in step S127 is performed by the B-side electric wire moving arm 166 carrying a B-side end portion of the segment electric wire W111 to the B-side crimping machine 164. The B-side crimping machine 164 is a mechanism constructed by setting the crimping portion in step S107 described above, and the B-side terminal T12 to be crimped is the terminal TR11a of the terminal reel set in step S107 together with the crimping portion. Further, by the B-side crimping processing in step S127, one terminal-equipped electric wire W11 in which the terminals are crimped to the both ends is completed.

In step S128 subsequent to step S127, the B-side electric wire moving arm 166 moves the completed terminal-equipped electric wire W11 to a discharging place which is opened to discharge the terminal-equipped electric wire W11. In the present embodiment, the discharging place and the discarding place in the discarding processing of step S112b are different from each other in the same portion on the apparatus.

Further, when the processing of steps S120 to S122 and the processing of steps S125 to S128 are performed in parallel, a determination result for the first crimping in step S123 subsequent to these processing is always NO. In this case, in step S124 to be executed next, the electric wire processing apparatus 1 determines whether the number of the terminal-equipped electrical wires W11 discharged in step S128 has reached the number of electrical wires to be manufactured specified in the product number data. If the number has been reached (YES determination in step S124), the processing is terminated.

On the other hand, when the number of electrical wires to be manufactured has not been reached (NO determination in step S124), the processing returns to step S115, and the subsequent processing are repeated. In this repetition, crimping when B-side crimping is performed for a last one of the electrical wires to be manufactured is the last crimping in this repetition operation. In this case, a determination result in step S119 is YES. In this case, only the processing of steps S125 to S128 is executed.

FIG. 15 is a schematic view showing a state in which only the processing of steps S125 to S128 is executed at a time of the last crimping in the flowchart of FIG. 10. Hereinafter, the processing of steps S125 to S128 at the time of the last crimping will be described with reference to FIG. 15 together with the flowchart in FIG. 10.

First, the processing is the B-side rubber plug insertion processing in step S125, but in this example, the rubber plug insertion processing in step S125 is not executed, and the stripping processing of the segment electric wire W111 in step S126 is executed. On the other hand, since the A-side stripping processing with respect to the electric wire W1-1 is not executed, an end portion thereof remains covered. Further, the B-side crimping processing on the segment electric wire W111 in step S127 is executed, and the last one of the terminal-equipped electric wire W11 to be manufactured is completed. The terminal-equipped electric wire W11 completed in step S128 following step S127 is discharged. A state of the main body mechanism 16 after the last discharging is terminated is the same as the state when the electric wire tip trimming in step S112 described above is terminated.

In this way, when the last crimping is terminated and the number of electric wires to be manufactured specified in the product number data is reached, the determination result in step S124 is YES, and the processing is terminated.

According to the electric wire processing apparatus 1 and the electric wire processing method of the embodiment described above, when the product number data is acquired as the manufacturing information by the information acquisition/control unit 11, a series of manufacturing operations from the various types of selection based on the product number data to the terminal crimping are performed under batch control. That is, according to the electric wire processing apparatus 1 and the electric wire processing method of the present embodiment, the entire operation for manufacturing the terminal-equipped electric wire W11 can be efficiently performed.

In the present embodiment, the information acquisition/control unit 11 performs operation control of each supply unit such that the supply of the electric wire W1-1 by the electric wire supply unit 13 and the supply of the terminal reels by the A-side terminal supply unit 15 and the B-side terminal supply unit 14 are executed in parallel. According to this configuration, since the supply of the electric wire W1-1 and the supply of the terminal reels are executed in parallel, the entire operation for manufacturing the terminal-equipped electric wire W11 can be performed more efficiently.

In the present embodiment, the product number data as the manufacturing information includes information for designating whether to perform only the cutting of the segment electric wire W111 without performing the terminal crimping or which one of the terminal-equipped electric wire of the one-end crimping type or the terminal-equipped electric wire of the both-end crimping type is to be manufactured. Further, when the both-end crimping type is selected, the information acquisition/control unit 11 operates the A-side crimping machine 161 and the B-side crimping machine 164 to crimp the terminals to the both ends of the segment electric wire W111. According to this configuration, in addition to the electric wire type and the terminal type, only the cutting of the segment electric wire W111 and the processing type such as the crimping type can be selected, whereby the degree of freedom in the electric wire processing can be improved.

In the present embodiment, in the case where the number of terminal-equipped electric wire to be manufactured specified is plural, the information acquisition/control unit 11 performs operation control such that the crimping by the A-side crimping machine 161 and the crimping by the B-side crimping machine 164 are executed in parallel except for a time of the first crimping and the time of the last crimping. The time of the first crimping is a time of crimping in the A-side crimping machine 161 before the first cutting, and the time of the last crimping is a time of crimping in the B-side crimping machine 164 after the last cutting. According to this configuration, since the crimping by the A-side crimping machine 161 and the crimping by the B-side crimping machine 164 are executed in parallel as appropriate, the entire operation for manufacturing the terminal-equipped electric wire W11 can be performed more efficiently.

In the present embodiment, the terminal supply units include the A-side terminal supply unit 15 and the B-side terminal supply unit 14. When the both-end crimping type is selected, the information acquisition/control unit 11 performs operation control that the supplies of the terminal reels on both the A side and the B side are executed in parallel. According to this configuration, since the supplies of the terminal reels are executed in parallel on the A side and the B side, the entire operation for manufacturing the terminal-equipped electric wire W11 can be performed more efficiently.

In the present embodiment, the product number data as the manufacturing information also includes information for designating which one of the terminal-equipped electric wire of the rubber plug insertion type and the terminal-equipped electric wire of the rubber plug non-insertion type is to be manufactured, and the type of the rubber plug. The rubber plug is selected from among the plurality of types of rubber plugs, and the A-side rubber plug supply unit 17a and the B-side rubber plug supply unit 17b which supply the rubber plug are also provided. According to this configuration, since the presence or absence of the rubber plug can be selected in the product number data in addition to the electric wire type and the terminal type, the degree of freedom in manufacturing the terminal-equipped electric wire W11 is improved.

In the present embodiment, when the rubber plug insertion type is selected in the product number data, the information acquisition/control unit 11 performs the operation control of the various supply units such that the supply of the electric wire, the supply of the terminal reel, and the supply of the rubber plug are executed in parallel. According to this configuration, in addition to the supply of the electric wire and the supply of the terminal reel, the supply of the rubber plug in the case where the rubber plug insertion type is selected is also executed in parallel, whereby the entire operation for manufacturing the terminal-equipped electric wire W11 can be performed more efficiently.

The embodiment described above merely shows a representative form of the electric wire processing apparatus and the electric wire processing method, and the electric wire processing apparatus and the electric wire processing method are not limited to the embodiment. That is, the electric wire processing apparatus and the electric wire processing method can be variously modified and implemented without departing from the gist thereof.

For example, in the above-described embodiment, as an example of the electric wire processing apparatus and the electric wire processing method, the electric wire processing apparatus 1 and the electric wire processing method in which the product number data is acquired as the manufacturing information for performing various types of selection are shown. However, the electric wire processing apparatus and the electric wire processing method are not limited thereto. For example, the manufacturing information in which selection information such as an electric wire type and a terminal type is directly listed may be acquired, and a specific information form of the manufacturing information is not particularly limited.

In the above-described embodiment, as an example of the electric wire processing apparatus and the electric wire processing method, the electric wire processing apparatus 1 and the electric wire processing method in which acquisition of the manufacturing information and various types of operation control are executed in one apparatus unit, that is, the information acquisition/control unit 11 are shown. However, the electric wire processing apparatus and the electric wire processing method are not limited thereto, and the acquisition of the manufacturing information and the various types of operation control may be performed by individual apparatus units.

In the above-described embodiment, as an example of a control unit, the information acquisition/control unit 11 that performs the operation control of each supply unit such that the supply of the electric wire W1-1 and the supply of the terminal reel are executed in parallel is shown. However, the control unit is not limited thereto, and may perform the operation control such that the supply of the electric wire and the supply of the terminal reel are sequentially performed. However, as described above, the supply of the electric wire W1-1 and the supply of the terminal reel are executed in parallel, whereby the entire operation for manufacturing the terminal-equipped electric wire W11 can be performed more efficiently.

In the above-described embodiment, as an example of the electric wire processing apparatus and the electric wire processing method, the electric wire processing apparatus 1 and the electric wire processing method capable of designating only the cutting of the segment electric wire or any one of the one-end crimping type and the both-end crimping type are shown. However, the electric wire processing apparatus and the electric wire processing method are not limited thereto, and one crimping type may be fixedly adopted for manufacturing the terminal-equipped electric wire. However, as described above, the crimping type can be selected, whereby the degree of freedom in the electric wire processing can be improved.

In the above-described embodiment, as an example of the control unit, the information acquisition/control unit 11 that causes the crimping by the A-side crimping machine 161 and the crimping by the B-side crimping machine 164 to be performed in parallel as appropriate is shown. However, the control unit is not limited thereto, and may perform control such that the A-side crimping and the B-side crimping are sequentially performed. However, as described above, the A-side crimping and the B-side crimping are performed in parallel as appropriate, the entire operation for manufacturing the terminal-equipped electric wire W11 can be performed more efficiently.

In the above-described embodiment, as an example of the control unit, the information acquisition/control unit 11 that performs the operation control such that the supplies of the terminal reels on both the A side and the B side are executed in parallel is shown. However, the control unit is not limited thereto, and may perform control such that terminal supply on the A side and terminal supply on the B side are sequentially performed. However, as described above, the terminal supply on the A side and the terminal supply on the B side are executed in parallel, whereby the entire operation for manufacturing the terminal-equipped electric wire W11 can be performed more efficiently.

In the above-described embodiment, as an example of the electric wire processing apparatus and the electric wire processing method, the electric wire processing apparatus 1 and the electric wire processing method capable of designating the presence or absence of the rubber plug are shown. However, the electric wire processing apparatus and the electric wire processing method are not limited thereto, and only the terminal crimping may be performed without handling the rubber plug. However, as described above, the presence or absence of the rubber plug can be selected, whereby the degree of freedom in manufacturing the terminal-equipped electric wire W11 can be improved.

In the above-described embodiment, as an example of the control unit, the information acquisition/control unit 11 that causes the supply of the electric wire, the supply of the terminal reel, and the supply of the rubber plug in parallel is shown. However, the control unit is not limited thereto, and may sequentially execute various types of supply including the supply of the rubber plug. However, as described above, the above-described various types of supplies are executed in parallel, the entire operation for manufacturing the terminal-equipped electric wire W11 can be performed more efficiently.

### REFERENCE SIGNS LIST

1 electric wire processing apparatus
11: information acquisition/control unit
12: electric wire storage rack
13: electric wire supply unit
14: B-side terminal supply unit
15: A-side terminal supply unit
16: main body mechanism
16a: cut-out portion
16a-1: reel-out mechanism
16a-2: cutting mechanism
17a: A-side rubber plug supply unit
17b: B-side rubber plug supply unit
121: rack body
122: electric wire reel
131: electric wire supply unit
131-1: supply arm
131a: electric wire protruding end portion
131b: opposite end portion
132: holding frame
132a: rotation axis
133: moving mechanism
133a: holding rail
133b: slide driving unit
133c: arm driving unit
141: terminal reel unit
141-1: one terminal reel unit
141a: reel holding portion
141b: crimping portion
141c: unit frame
142: supply mechanism
142a: receiving slot
161: A-side crimping machine
162: A-side rubber plug inserting machine
163: A-side electric wire moving arm
164: B-side crimping machine
165: B-side rubber plug inserting machine
166: B-side electric wire moving arm
D11: reel-out direction
D12, D13, and D16: arrow
D14: length direction
D15: width direction
D17: arrangement direction
P11: supply position
P12: crimping machine set position
S11: standby posture
S12: electric wire supply posture
T11: A-side terminal
T12: B-side terminal
TR1: terminal reel
TR11: terminal chain body
TR11a: terminal
TR11b: carrier
W1: electric wire
W1a: tip
W1-1: electric wire
W11: terminal-equipped electric wire
W111: segment electric wire
Y: operator

What is claimed is:

1. An electric wire processing apparatus comprising:
an information acquisition unit configured to, in order to cut out a segment electric wire or to manufacture a terminal-equipped electric wire in which a terminal is crimped to at least one end of the segment electric wire, acquire manufacturing information including a type of electric wire for the segment electric wire and a type of terminal for the terminal;
an electric wire supply unit configured to hold a plurality of types of electric wires, and to supply, in response to selection of an electric wire to be used out of the plurality of types of electric wires, the electric wire to be used;
a terminal supply unit configured to hold a plurality of types of terminal reels each having a terminal type different from each other, wherein a band-shaped terminal chain body in which a plurality of terminals is connected to each other is wound around each of the terminal reels, the terminal supply unit being configured to supply, in response to selection of a terminal reel to be used out of the plurality of types of terminal reels, the terminal reel to be used;
a main body mechanism configured to cut out the segment electric wire from the electric wire to be used or to manufacture the terminal-equipped electric wire by crimping the terminal of the terminal reel to be used to at least the one end of the segment electric wire; and
a control unit configured to select the electric wire to be used and the terminal reel to be used for the electric wire supply unit and the terminal supply unit based on the manufacturing information acquired by the information acquisition unit, and to control each of the information acquisition unit, the electric wire supply unit, the terminal supply unit, and the main body mechanism.

2. The electric wire processing apparatus according to claim 1, wherein
the control unit is configured to control the electric wire supply unit and the terminal supply unit such that the supply of the electric wire by the electric wire supply unit and the supply of the terminal reel by the terminal supply unit are executed in parallel.

3. The electric wire processing apparatus according to claim 1, wherein
the manufacturing information includes information indicating whether or not only the cutting out of the segment electric wire without performing terminal crimping is to be performed or indicating which one of following types of the terminal-equipped electric wire to be manufactured: an one-end crimping type in which the terminal is crimped only to the one end of the segment electric wire; and a both-end crimping type in which the terminals are crimped to both ends of the segment electric wire,
the main body mechanism includes
a cut-out portion configured to cut out the segment electric wire by reeling out the electric wire in a predetermined reel-out direction and cutting the electric wire,
an A-side crimping machine configured to crimp a terminal of the terminal reel to a front end of the electric wire in the reel-out direction, and
a B-side crimping machine configured to crimp a terminal of the terminal reel to a rear end, in the reel-out direction, of a terminal-equipped segment electric wire cut out after receiving the terminal crimping by the A-side crimping machine, and
in a case where the both-end crimping type is selected in the manufacturing information, the control unit operates the A-side crimping machine and the B-side crimping machine to crimp the terminals to the both ends of the segment electric wire.

4. The electric wire processing apparatus according to claim 3, wherein
the manufacturing information includes information for designating the number of segment electric wires or terminal-equipped electric wires to be manufactured, and
in a case where the both-end crimping type is selected and the number of terminal-equipped electric wires to be manufactured is plural in the manufacturing information, the control unit operates the A-side crimping machine and the B-side crimping machine such that the crimping by the A-side crimping machine and the crimping by the B-side crimping machine are executed in parallel except at a time of crimping by the A-side crimping machine before a first cutting out and at a time of crimping by the B-side crimping machine after a last cutting out.

5. The electric wire processing apparatus according to claim 3, wherein
the terminal supply unit includes
an A-side terminal supply unit configured to hold a plurality of types of terminal reels for the A-side crimping machine, and to supply, in response to selection of a terminal reel to be used for the A-side crimping machine, the terminal reel to be used, and
a B-side terminal supply unit configured to hold a plurality of types of terminal reels for the B-side crimping machine, and to supply, in response to selection of a terminal reel to be used for the B-side crimping machine, the terminal reel to be used, and
in the case where the both-end crimping type is selected in the manufacturing information, the control unit controls the terminal supply unit such that the supply of the terminal reel by the A-side terminal supply unit and the supply of the terminal reel by the B-side terminal supply unit are executed in parallel.

6. The electric wire processing apparatus according to claim 1, wherein
the manufacturing information includes information indicating which one of following types of the terminal-equipped electric wire to be manufactured: a rubber plug insertion type in which terminal crimping is performed from above a rubber plug inserted into at least the one end of the segment electric wire; and a rubber plug non-insertion type in which the terminal crimping is directly performed on at least the one end of the segment electric wire, and indicating a type of the rubber plug,
the electric wire processing apparatus further comprises a rubber plug supply unit configured to hold a plurality of types of rubber plugs, and to supply, in response to selection of a rubber plug to be used out of the plurality of types of rubber plugs, the rubber plug to be used,
the main body mechanism is configured to insert the rubber plug to be used prior to the terminal crimping, and
in a case where the rubber plug insertion type is selected in the manufacturing information, the control unit selects the rubber plug to be used for the rubber plug supply unit, and controls the main body mechanism such that the rubber plug to be used is inserted prior to the terminal crimping.

7. The electric wire processing apparatus according to claim 6, wherein
in the case where the rubber plug insertion type is selected in the manufacturing information, the control unit controls the electric wire supply unit, the terminal supply unit, and the rubber plug supply unit such that the supply of the electric wire by the electric wire supply unit, the supply of the terminal reel by the terminal supply unit, and the supply of the rubber plug by the rubber plug supply unit are executed in parallel.

8. An electric wire processing method comprising:
an information acquisition process of acquiring the manufacturing information by the information acquisition unit in the electric wire processing apparatus according to claim 1;
a selection process of selecting, by the control unit, the electric wire and the terminal reel for the electric wire supply unit and the terminal supply unit based on the manufacturing information acquired by the information acquisition unit;
a supply process of supplying the electric wire by the electric wire supply unit and supplying the terminal reel by the terminal supply unit; and
a manufacturing process of cutting out the segment electric wire or manufacturing the terminal-equipped electric wire by the main body mechanism.
